(19) United States
(12) Patent Application Publication
(10) Pub. No.: US 2008/0150852 A1
(43) Pub. Date: Jun. 26, 2008

(54) Active Matrix Display Devices

(75) Inventor: Martin J. Edwards, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,822

(22) PCT Filed: Feb. 7, 2005
(86) PCT No.: PCT/IB05/50485

§ 371 Date: Aug. 9, 2006

(30) Foreign Application Priority Data
Feb. 14, 2004 (GB) 0403308.0

(51) Int. Cl. G09G 3/36

(52) U.S. Cl. 345/87

(57) ABSTRACT

An active matrix display device, such as an AMLCD, having sets of row and column address conductors (18, 19) connected to a row and column array of picture elements (12) and drive means (21, 23, 25) for supplying selection and data signals to the sets of rows and column address conductors respectively uses a plurality of serial charge redistribution digital to analogue conversion means (30) to convert multi-bit digital data signals supplied to the column address conductors (19) into analogue voltage levels for use by the picture elements. Each conversion means uses the capacitances of two column address conductors between which charge is shared by operation of conversion switches (31). The drive means is arranged to supply data signals alternately to the two column address conductors of each conversion means. This leads to a reduction in conversion errors and consequential unwanted display artefacts. Preferably, the column address conductor to which data signals are applied is changed after one or more complete multi-bit conversions performed by the conversion means. The required change over is accomplished using a simple switch arrangement.

The present invention relates to active matrix display devices, such as active matrix liquid crystal display (AMLCD) devices, and more particularly to active matrix display devices comprising a row and column array of picture elements, sets of row and column address conductors for selecting rows of picture elements and providing data signals to the picture elements of a selected row respectively, drive means for supplying selection signals and multi-bit digital data signals respectively to the set of row address conductors and the set of column address conductors, and in which the multi-bit digital data signals supplied to the column address conductors are converted into analogue voltage levels for use by the picture elements by a plurality of serial charge redistribution digital to analogue conversion means, each conversion means comprising at least first and second capacitances interconnectable by at least one conversion switch and between which charge is shared, and in which the first and second capacitances of a conversion means are provided by the capacitances of two column address conductors.

Such a display device is described in WO 02/21496, whose disclosure is incorporated herein by reference. The provision of the digital to analogue conversion means at least in part within the active matrix circuitry, and using components of that circuitry, offers many advantages over conventional arrangements in which digital data signals are converted by D/A (digital to analogue) converters located outside the array into analogue (amplitude modulated) signals which are supplied by a column drive circuit to the column address conductors. In particular, the column drive circuit can be implemented using purely digital, and relatively simple, circuitry, thereby making it capable of operating at comparatively high speeds, and also enabling it conveniently to be integrated on a substrate of the display device together with the active matrix circuitry similarly using thin film transistors, TFTs. As the converted analogue voltage is formed directly on the capacitance of a column conductor the need for a buffer amplifier to drive the column capacitance is removed. Further, the use of the inherent capacitance of a column conductor to form the converter means avoids the need to provide capacitors within the separate column drive circuit, and, in the case of a display device with an integrated drive circuit, therefore reduces the area required for this circuit at the periphery of the display device. Also, the signals applied to the column conductor by the external or integrated column drive circuits can be purely digital, or switching signals consisting of two or more discrete voltage levels, thus simplifying the requirements of the column drive circuits.

In this known device, the two column conductors of a D/A conversion means comprise a pair of adjacent column address conductors. In operation a first, least significant, bit of the multi-bit digital data signal is supplied, via a first switch, to one column conductor of the pair and stored as charge on the inherent capacitance of the column address conductor. This capacitance is typically formed from the individual capacitances between the column address conductor and the row address conductors where they cross over one another, and also the capacitances presented by the switching devices associated with the picture elements through which signals on the column address conductor are supplied to the picture element electrodes. The column address conductor capacitances may also include a capacitance between the conductor and the picture element electrodes and, particularly in the case of an AMLCD, a capacitance between the column address conductor and the common electrode carried on a substrate facing the substrate carrying the active matrix array, with the intervening liquid crystal layer acting as dielectric. Generally, the capacitances exhibited by each of the column address conductors should be similar, and, as the device has a regular structure, the column conductor capacitance is distributed uniformly along the length of the column conductor. Following the charging of the one column conductor capacitance by application of the first bit of the multi-bit signal, the first switch is opened and a conversion switch connecting the one column conductor to the other column conductor of the pair is closed so that the stored charge is shared on both column address conductors. The conversion switch is then opened and the first switch closed again to allow the next bit of the multi-bit data signal to be used to charge the one column address conductor again. This is followed by the opening of the first switch and closing of the conversion switch to result again in charge sharing between the two conductors. This cycle is repeated for all subsequent bits of the data signal, so that, following application of the last, most significant, bit, and after the final operation of the conversion switch, a voltage level is obtained on both column conductors which is determined by the multi-bit digital data signal, and which, in turn, determines the grey level obtained from a picture element.

The other column address conductors of the set are similarly paired, with each pair being used as part of a respective D/A conversion means, and multi-bit digital data signals supplied simultaneously to respective pairs in similar manner in order to address picture elements in one row. With this pairing arrangement, the multi-bit digital data signals applied to the column conductors are intended for alternate picture elements in the row and when the conversion process is completed these picture elements are selected by means of a selection signal applied to a row address conductor associated with these alternate picture elements in the row concerned, thereby turning on their switching devices and transferring the voltages stored on one of the column address conductors of each pair to the associated picture element electrodes. The process is then repeated using data signals intended for the remaining picture elements in the same row, with the voltages being established on the column address conductors by conversion being transferred to the picture element electrodes of these other picture elements by means of selection signal applied to another row address conductor associated with these other picture elements. Each row of picture elements in the array is addressed in this fashion in turn.

It has been found that problems may occur with image display quality in the form of short range vertical cross talk type effects. Longer range vertical banding effects can also be experienced.

It is an object of the present invention to provide an improved display device of the kind using column conductor capacitances for D/A conversion purposes.

It is another object of the present invention to provide a display device of the kind described in the opening paragraph in which the quality of the display image is improved.

According to an aspect of the present invention, there is provided a display device of the kind described in the opening paragraph wherein the drive means is arranged to alternate the supply of data signals to the first and second column conductors of the conversion means.

Thus, unlike the known arrangement in which the data signals are applied only to one address conductor, the address conductor to which data signals are applied is changed from time to time instead.

Preferably, the column conductor to which data signals are applied is changed after at least one complete multi-bit signal conversion. The change may, therefore, be each time a picture element in a column of picture elements is addressed, which corresponds to a half row address period in the drive scheme used in WO 02/21496 and as described above. Alternatively, the change could take place after a plurality of conversions, corresponding to a plurality of picture elements in a column being addressed, and to n/2 row address periods where n is the number of picture elements concerned, or possibly after each complete frame. On the other hand, it is envisaged that the change may occur during each conversion process, after a predetermined number, m, of individual bits of a multi bit data signal, where m≧1. When the alternation occurs within each multi-bit conversion or after a number of conversions which is less than the number of picture element rows in the array, the column conductor to which a data signal is initially supplied is preferably changed each frame as well.

The frequency of alternation that is selected will depend to a large extent on the precise nature of the cause of the unwanted artefacts and also variables such as the kind of any inversion drive scheme used.

The alternating of the column address conductor of a conversion means to which the input data is applied leads to significant improvement in the quality of the display image. This results from the different manner in which the data signals are presented compared with that of the known device and the effect this has on the operation of the device. In the known arrangement, the nature of the waveforms appearing on the two column conductor capacitances of a conversion means are quite different to each other. In successive converter periods one capacitance is charged to the voltage level of the input data and then the voltage changes to an intermediate level when charge sharing takes place, while the voltage on the other capacitance only steps through each of the intermediate voltage levels. Due to the capacitances typically existing in active matrix display devices that contribute to the column conductor capacitances used in the conversions means, differences in the shape of the consequential voltage waveforms can result in differences in the effective values of the two capacitances. This leads to errors occurring in the conversions.

For example, in the case of an AMLCD where one contributory capacitance is that between a column conductor and the common electrode shared by the picture elements and carried on an opposing substrate with the intervening LC layer serving as a dielectric, the dielectric constant of the LC material is dependent to an extent on the applied voltage, and if the voltage waveforms appearing on the two column conductors constituting a conversion means differ significantly then a difference in the two column conductor capacitances will result. The conversion error caused by this difference can produce short range vertical crosstalk type effects.

By alternating the supply of input data to the two column conductor capacitances, the difference in the shape of the voltage waveforms experienced by the two column capacitances is minimised, thereby eliminating, or at least reducing, the above described effects.

For an AMLCD, the alternation preferably is carried out with a period which is short compared to the response time of the LC material. In this way the mean values of the voltages on the two column conductors integrated over the response time of the LC material will be closer and the capacitance between the column conductors and the common electrode for the two columns will be similar.

Also, coupling of the column conductor voltage waveforms onto the picture element electrodes can occur due to capacitance between the column conductor and the picture element electrodes. This can disturb the picture element voltage, and therefore the brightness of the picture elements. If the voltage waveforms on the two column conductors are very different in shape then some difference in the brightness of picture elements associated with the first and second column conductors can be expected, resulting in non-uniformity of the displayed images. Again, by alternating the column conductor to which data signals are applied, the shape of the voltage waveforms on the two column conductors can be made similar so that the effect of the coupling is then similar for picture elements associated with the first and second column conductors. As the picture elements will tend to respond to the mean column voltage evaluated over the response time of the material, then alternating the data signal input preferably with a period which is short compared to the LC material's response time will lead to significant improvement.

The alternation of the supplied data signals may be accomplished conveniently using a switch arrangement to route an input data signal to one or the other of the two column conductors forming a conversion means.

For simplicity, the switch arrangements of the plurality of conversion means are preferably operated together using common control signals.

The switch arrangement may comprise simply a switch between each of the two column conductors constituting the conversion means and a serial digital data signal output from the drive means. This provides an additional advantage in that the switch arrangement is symmetrical with respect to each column conductor pair, (i.e., each column conductor has a similar number of switches connected to it), and consequently the capacitances of the two column conductors will be substantially matched in order to minimise conversion errors.

In display devices such as AMLCDs, it is necessary to invert periodically the polarity of the drive voltages applied to the picture elements. This inversion is normally carried out each time a picture element is addressed. Such inversion can be achieved simply and conveniently by inverting each bit of the multi-bit digital data signal applied to the input of a conversion means.

Preferably, in order to reduce further the effect of any conversion errors on the quality of the display image, the drive means and the conversion means are arranged to operate such that the column conductor to which data is applied is alternated in synchronism with the inversion of the picture element drive voltage. In successive addressing periods of an individual picture element, then the column conductor of its associated conversion means to which data is applied to generate the analogue voltage for the picture element may be changed each time the polarity of the drive voltage for the picture element is inverted, or every second time that the drive voltage is inverted. This reduces the effect any conversion errors have on the rms voltage experienced by the picture element. In other words, a non-inverted input data is applied to a first column conductor of its associated conversion means, followed by inverted input data to the second column conductor, followed by non-inverted input data to the first conductor again, and so on, or, alternatively, a non-inverted input data is applied to a first column conductor, followed by an inverted data input to the first conductor, followed by a non-inverted data input to the second column conductor, followed by an inverted data input to the second column conductor, followed by a non-inverted data input to the first column conductor, and so on.

Although intended particularly for AMLCDs, it is envisaged the invention may be used to advantage with other kinds of active matrix display devices.

Embodiments of active matrix display devices, and in particular AMLCDs, in accordance with the invention will now be described, by way of example, with reference to the accompanying drawings, in which:—

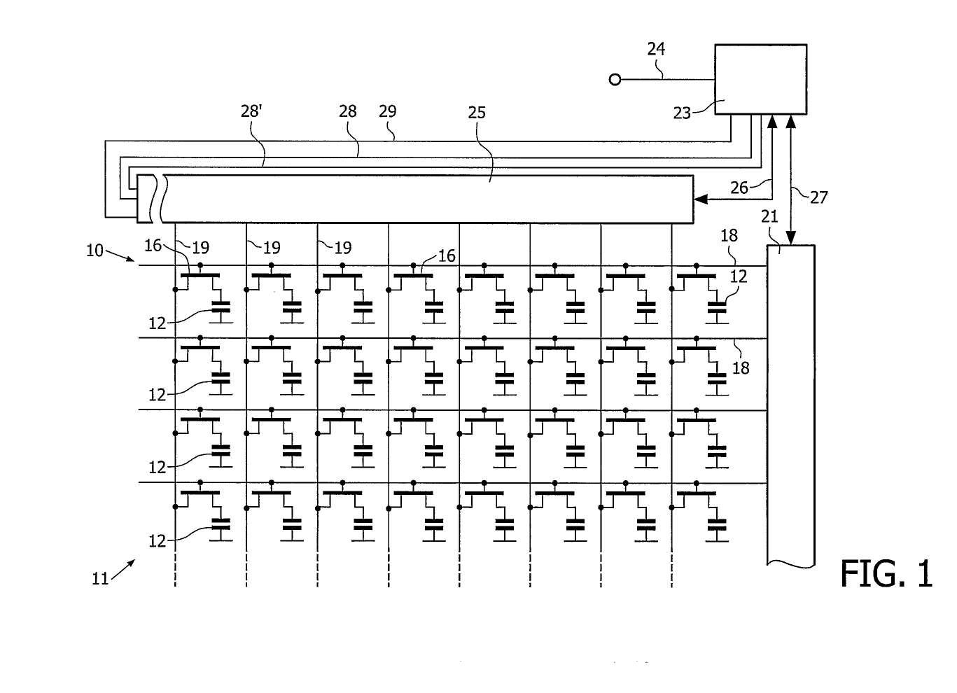

FIG. 1 is a schematic block diagram of an embodiment of AMLCD according to the invention;

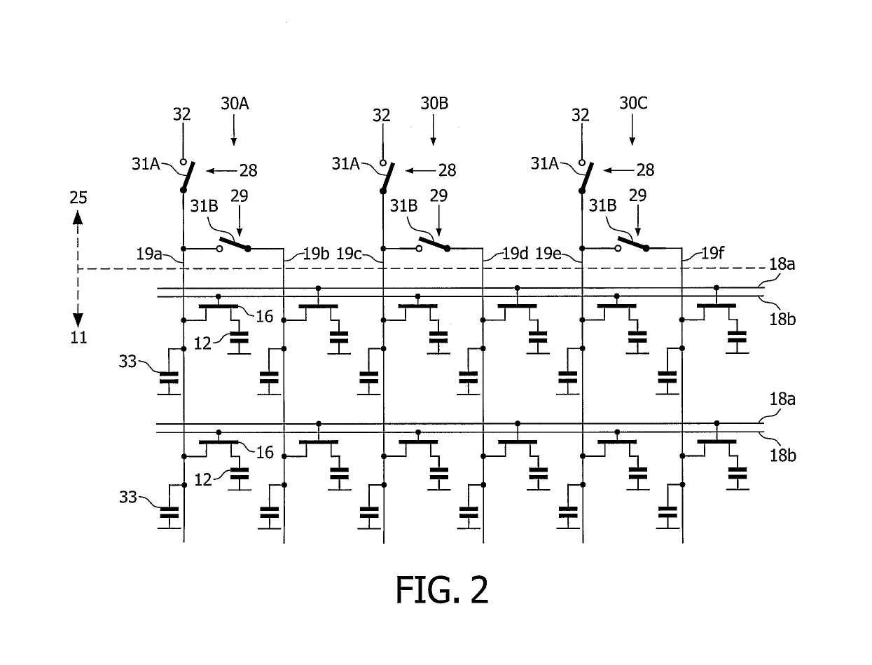

FIG. 2 shows schematically the circuit configuration of part of a known AMLCD;

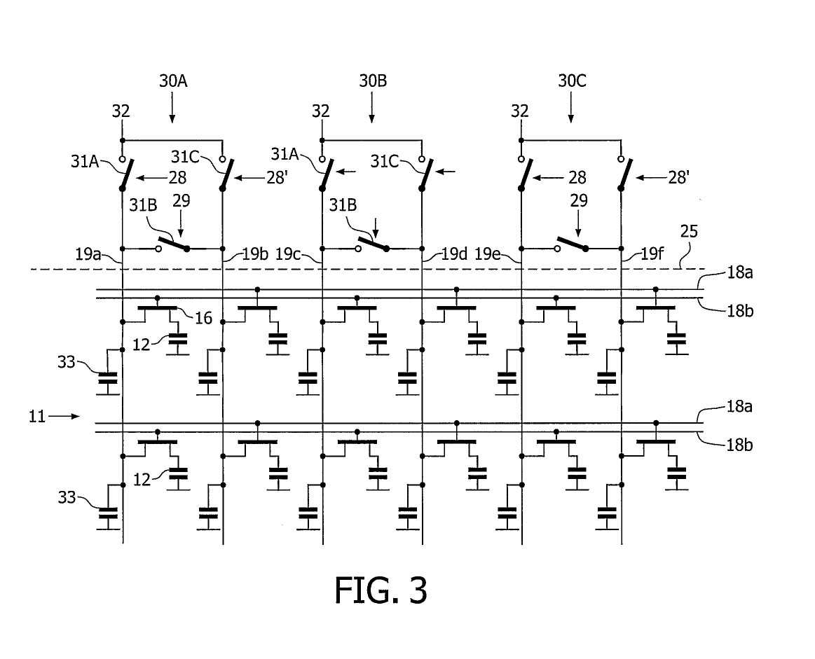

FIG. 3 shows schematically the circuit configuration of part of the display device of FIG. 1;

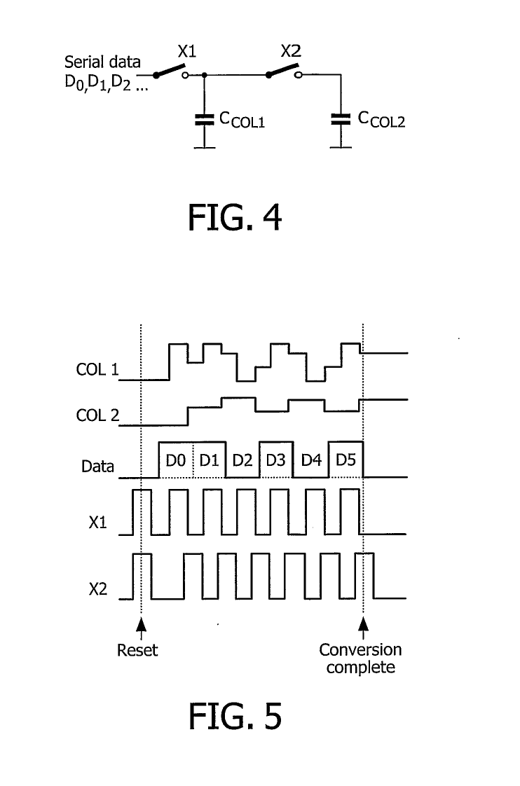

FIG. 4 shows diagrammatically a serial charge redistribution type D/A conversion circuit used in the device of FIG. 2;

FIG. 5 illustrates example waveforms appearing in operation of the circuit of FIG. 4;

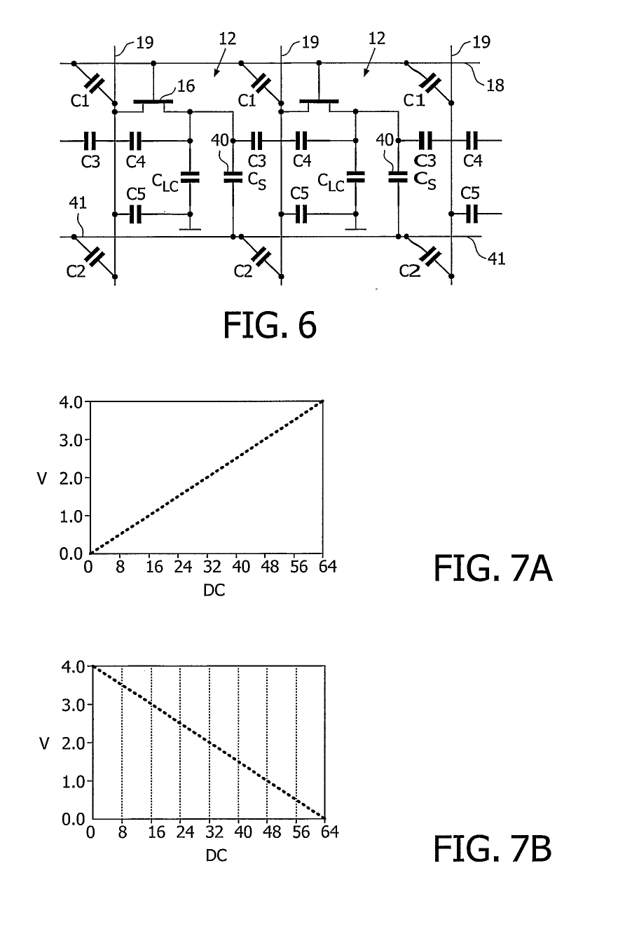

FIG. 6 illustrates various capacitancies present in a typical AMLCD; and

FIGS. 7A and 7B graphically illustrate the accumulative effects of different types of input data.

The same reference numbers are used throughout the Figures to indicate the same or similar parts.

Referring to FIG. 1 the active matrix display device comprises an AMLCD having a row and column array 11 of picture elements 12 formed in a display panel 10. The picture elements 12 include liquid crystal display elements formed by spaced electrodes carried respectively on the opposing surfaces of spaced first and second substrates with twisted nematic LC material disposed therebetween. The display element electrodes on the first substrate comprise respective portions of an electrode layer common to all picture elements in the array while the other electrodes of the display elements of the picture elements comprise individual, spaced, electrodes carried on the second substrate together with their associated active matrix addressing circuitry. The picture elements 12 further include switching TFTs 16 which are connected to crossing sets of row address conductors 18 and column address conductors 19 carried on the second substrate. Drive signals for driving the picture elements are supplied to these sets of conductors from a peripheral drive circuit comprising a row drive circuit 21 and a column drive circuit 25, both of which circuits comprise digital circuitry integrated on the second substrate. The row drive circuit 21 is operable to scan the rows of picture elements in turn in each frame period via the row address conductors 18 by applying switching waveform signals to the row conductors, which operation is repeated for successive frames and is controlled by timing signals provided from a timing and control circuit 23 to which an input signal 24 is supplied. The input signal can be either analogue or digital video (picture) data, e.g. a TV signal or a computer video signal. Control and data signals are exchanged between the control circuit 23 and the row drive circuit 21 and column drive circuit 25 along buses 26, 27. The column drive circuit 25 is supplied with digital video data (via an A/D converter if analogue input is used) and operates to apply to the set of column address conductors 19, appropriately in parallel for respective picture elements in a row and in synchronism with scanning of the rows, data signals in a serial multi-bit digital form. The digital data input signal supplied to the column drive circuit 25 is demultiplexed within the circuit and samples from a complete line of (video) information are stored in latch circuits of the circuit 25 as appropriate to their associated column of picture elements. As in a conventional display devices, the writing of the (video) information to the picture elements takes placed on a row by row basis in which a line of video information is sampled by the column drive circuit 25 and subsequently written to the picture elements 12 in a selected row via the column conductors, the identity of the selected row being determined by the row drive circuit 21. Unlike conventional display devices, however the video information supplied by the column drive circuit to a column conductor for a picture element is in a serial, multi-bit, digital form rather than analogue (amplitude modulated) form.

The column address conductors 19 each have an associated capacitance, which is distributed along the length of said column conductors. Each column capacitance comprises the capacitance between the column conductor 19 and other electrodes within the display device. This column capacitance may include the capacitance between the column conductor 19 and the row electrodes 18 at their cross-over regions, the two being separated by a dielectric layer, the capacitance between the column conductor and the common electrode on the first substrate of the display device, in which case the liquid crystal layer forms the dielectric layer, the source-gate capacitance of the sources of the TFTs 16 of the picture elements associated with the column conductor, and the capacitance between the column conductor and closely adjacent display element electrodes. As the active matrix display has a regular structure, the column capacitance typically will be distributed uniformly along the length of the column conductor.

The display device of FIG. 1 includes a plurality of D/A conversion means which are provided in part within the column drive circuit 25 and in part by the capacitances associated with the column address conductors 19.

FIG. 2 shows schematically part of the D/A conversion means in a known display device, as described in WO 02/21496, the D/A conversion means being of the serial charge redistribution type.

In this known arrangement, each D/A conversion means, 30, serves two neighbouring columns of picture elements and three such conversion means, 30A, 30B, and 30C, addressing six successive picture elements 12 in a row, are shown in FIG. 2. It will be appreciated that there will typically be several hundred columns of picture elements in the display device, and therefore many more conversion means, but only a few are shown in FIG. 2 for simplicity.

Each D/A conversion means 30 comprises a respective, and separate, pair of directly adjacent column conductors 19, with successive conversion means 30 using successive adjacent pairs of column conductors in the set. Thus, conversion means 30A comprises column conductors 19a and 19b, conversion means 30B comprises column conductors 19c and 19d, etc. The capacitances of the column conductors 19 are represented in FIG. 2 by the capacitors 33, each capacitor 33 denoting the capacitance in the region of a picture element. Considering, for example, conversion means 30A, the two column conductors 19a and 19b are connected at their one ends to a respective serial digital data output 32 within the circuit 25 via conversion switches 31A and 31B, the switch 31B being operable by the control line 29 from the timing and control unit 23 (FIG. 1) to connect the column conductor 19b to the column conductor 19a, and the switch 31A being operable by the control line 28 from the unit 23 to connect the input 32 to the column conductor 19a. Each row of the picture elements is associated with a respective pair of row address conductors, 18a and 18b, with the gates of the TFTs 16 of alternate picture elements being connected to one row conductor 18a and the gates of the TFTs of the remaining picture elements being connected to the other row conductor 18b.

In operation, a row of picture elements is addressed in a respective period in the following manner. Serial multi-bit digital data, representing particular required grey levels, is supplied to the outputs 32 in the column drive circuit 25. Considering the conversion means 30A for example, then in the row address period a voltage representing the first, least significant, bit of the multi-bit signal for one of the two picture elements in the row that are associated with the column conductors 19a and 19b is supplied to the output 32 and the switch 31A is closed, while switch 31B remains open, so that the capacitance of the column conductor 19a is charged to a voltage level according to that bit. The switch 31A is then opened and the switch 31B closed so that the charge is shared on both conductors 19a and 19b. Switch 31B is then opened and switch 31A closed again, and a voltage representing the next bit of the multi-bit signal applied to the input 32 causing the column conductor 19a to be charged to a level dependent on this next bit. Switch 31A is then opened and switch 31B closed to share the charge between the conductors 19a and 19b. This procedure is repeated for all subsequent bits of the digital signal up to the most significant bit.

The other conversion means, 30B, 30C, etc, are operated in similar manner simultaneously with this operation of the conversion means 30A and with the appropriate multi-bit data signals applied from the respective outputs 32.

At the end of this procedure, after the last, most significant, bit of the multi-bit data signal has been applied and the conversion switch 31B has been closed, the two column conductors 19 associated with a conversion means are both charged to a required converted voltage level which is dependent on the applied digital signal. A selection (gating) signal is then applied by the row drive circuit 21 to the appropriate one of the two row conductors 18a and 18b associated with the picture element row being addressed, for example, the conductor 18a, to turn on the TFTs 16 of the picture elements connected to that row conductor, whereby the display elements of those picture elements are charged according to the level of the converted voltage on the column conductor 19a, 19c, etc, with the grey levels of the picture elements being determined by the voltages. Alternate picture elements in the row are thus addressed with their respective required voltages.

In the latter part of the same row address period, the above operation is repeated, using multi-bit digital data intended for the other picture elements in the row, and at the end of the conversion phase, through which the pairs of column conductors 19 of each conversion means 30 are charged to a level dependent on the applied digital signals, the other row conductor, 18b, is selected by the row drive circuit 21 to result in the converted voltages being transferred to the display elements of the remaining picture elements in the row.

Successive rows of picture elements in the array are addressed in similar fashion in sequence, in respective row address periods, and this operation is repeated for successive frames. Although not shown in FIG. 2, each column conductor 19 may be connected to a switch at its other end, as described in WO 02/21496, which is operable to reset the column conductor voltage at the start of each addressing cycle, before that conversion process begins.

Referring now to FIG. 3, there is shown schematically the circuit configuration of a part of the embodiment of display device of FIG. 1 according to the present invention. The circuit configuration, and manner of its operation, are similar in many respects to that of FIG. 2, except for details of the conversion means and their particular manner of operation.

The conversion means are modified so as to alternate the column conductor of a conversion means to which input data is applied. Such alternation can reduce the risk of differences in the two column conductor capacitances of a conversion means, and the possibility of undesirable crosstalk effects, as will be explained subsequently. The ability to alternate the application of input data between the two column conductors is achieved through an additional switch 31C which is selectively operable by a control signal on a control line 28′ from the unit 23 so as to connect the other column conductor of a conversion means to the serial digital data output 32. The switch 31C together with the switch 31A form a change-over switch arrangement, the switches 31A and 31C being operable in complementary fashion to enable the data to be passed to either one of the two column conductors. Considering the conversion means 30A for example, then the switches 31A and 31C operate to allow digital data at the output 32 to pass selectively to the column conductor 19a or the column conductor 19b respectively. The switches 31A and 31C of each conversion means 30A, 30B etc are operated in similar manner at the same time using common control signals. The digital data can be applied to the first column conductor of each pair by closing the switches 31A. Alternatively, the input data can be applied to the second column conductors of each pair by closing the switches 31C. With this arrangement switches 31A and 31C may be operated for alternate data conversions, although it may be preferable to alternate which column conductor the data is applied to in some other sequence depending on the details of the display design, for example colour filter layout, for example, with so-called delta colour picture element configurations in which successive picture elements sharing the same column conductor are of different colours.

In this embodiment, the change-over switches 31A and 31C are operated after each complete multi-bit data signal conversion process generating an analogue drive voltage for a picture element so that the column conductor to which the data signals are applied is alternated after each successive conversion, and thus twice each row address period. The column conductor to which a data signal is applied is preferably also changed for each successive frame as well, so that, for a given picture element, the data signal in one frame is applied to one of the two column conductors and in the next frame the data signal is applied to the other column conductor.

The advantages of alternating the supply of input data between the two column conductors will now be explained with reference to FIGS. 4, 5 and 6. FIG. 4 schematically shows the equivalent circuit of the serial charge redistribution conversion means of the device of FIG. 2, with C_{COL1} and C_{COL2} representing the capacitances of the two column conductors concerned, X₁ and X₂ representing the switches 31A and 31B, and Dₒ, D₁, D₂ etc denoting the individual bits of a serial multi-bit data signal. FIG. 5 shows example waveforms present on the two column conductors, COL1 and COL2, in a conversion period produced by the data signal waveform, Data, from the associated output 32, and X1 and X2 show the switching signal waveforms applied to the switches X1 and X2. At the start of the conversion process, the voltage on the two capacitances C_{COL}, and C_{COL2} can be reset by applying a reset voltage to the input of the circuit and closing switches X1 and X2 simultaneously. The individual bits of the input digital data are then applied serially to the input of the converter circuit with the least significant bit first. The switches X1 and X2 are operated to first apply each bit to the first capacitor and then to carry out a charge sharing operation with the second capacitor. At the end of the conversion, after the final charge sharing operation, the converted analogue voltage is present on both capacitors.

It can be seen from the waveforms shown in FIG. 5 that the nature of the voltage waveforms appearing on the two capacitors differs significantly. In successive converter periods the first capacitor is charged to the voltage level of the input data and then the voltage changes to an intermediate level when the charge sharing operation takes place. The voltage on the second capacitor on the other hand simply steps through each of the intermediate voltage levels.

FIG. 6 illustrates schematically various capacitances which can be present in a typical AMLCD and associated with the column conductors. In FIG. 6, C_{LC} is the capacitance of a display element, C1 represents the cross-over capacitance between individual row and column conductors 18 and 19, and C2 represents the capacitance between an electrode of a picture element storage capacitor 40 (if present) and a column conductor, which storage capacitor is usually connected between the display element electrode of the picture element and a supplementary capacitor line that extends parallel to the row conductors 18. C3 and C4 represent the capacitances between a column conductor 19 and the display element electrodes of adjacent picture elements, and C5 represents the capacitance between a column conductor 19 and the common electrode of the array carried on a substrate spaced from the substrate carrying the active matrix circuitry by the layer of LC material.

It is important to the operation of the serial charge redistribution D/A conversion means that the two capacitances forming the conversion means, comprising the capacitances associated with the two column conductors employed, should have closely matched values. Although in the above description with regard to the circuit of FIG. 2 it has been supposed that these two capacitances are substantially equal, this will not actually be the case and there can be significant differences. Such differences in the values of the two capacitances lead to errors in the output voltage of the conversion means since charge sharing, and thus the voltages established on the two column conductors of a conversion means upon closing of the switch 31B, will not be equal.

The column conductor capacitance is dependent on the values of C1 and C5 and these values are not necessarily the same for all picture elements but may vary from picture element to picture element over the array due to effects such as alignment and dielectric layer thickness variations. The effect that these variations in C1 and C5 have on the matching of the capacitance of a pair of column conductors can be minimised by forming a conversion means using a pair of column conductors which are located physically close to each other, as in the circuit configuration of FIG. 2. However, this does not apply with regard to the effects of other capacitances.

The capacitance C_{LC} of a display element is dependent on the drive voltage applied to the display element, and therefore varies with the brightness (grey scale) of the display element. For example, C_{LC} for a dark display element may be larger than C_{LC} for a light display element. This means that the column conductor capacitance will depend to some extent on the capacitance of display elements in close proximity. The effect this has on the column conductor capacitance is, though, limited because it is effectively connected in parallel with Cs, the capacitance of the storage capacitor 40, and in series with C3 and C4 when considering column conductor capacitance.

As indicated above, one component of the column conductor capacitance will be the capacitance between a column conductor and the common electrode of the display, labelled C5 in FIG. 6. This capacitance includes the liquid crystal layer as a dielectric, and the dielectric constant of the liquid crystal depends on the applied voltage. If the voltage waveforms appearing on the two column conductors which form a conversion means are significantly different then a difference in the capacitances of the column conductors can result due to a difference in the values of the capacitance between the column conductors and the common electrode.

In addition, coupling of the column conductor voltage waveforms on the display element electrodes can occur due to the capacitances C3 and C4 between the column conductor and the electrodes. This can disturb the picture elements' voltage, and therefore the brightness of the picture elements. If the shape of the voltage waveforms on the two column conductors of the pair differ significantly then differences in the brightness of the picture elements associated with these column conductors, will result, leading to non-uniformity of displayed images such as vertical banding effects.

The risk of such capacitance differences and crosstalk effects are significantly reduced by alternating the column conductor of the pair to which the input data is applied. The difference in the shape of the waveforms appearing on each of the two column conductors of a conversion means will then generally be minimised.

The alternation preferably is carried out with period that is short compared to the response time of the LC material, so that the mean values of the voltages on the two column conductors integrated over the LC material's response time will be closer and the capacitance between the column conductors and the common electrode will be similar for the two column conductors.

A further aspect of using these serial charge redistribution D/A conversion means to generate the drive voltage for the picture elements in an AMLCD is the need to invert periodically the polarity of the drive voltage applied to the picture elements. This is normally carried out each time that the picture element is addressed. The inversion of the output voltage of the conversion means which is required can be achieved very simply by inverting each bit of the digital data that is applied to the input of the conversion means. The effect that this has on the converted voltage is illustrated in FIGS. 7A and 7B which show graphically the relationship between the output voltage, V, (here in the range of 0 to 4 volts by way of example) produced by a conversion means against applied digital code, DC, for non-inverted data and inverted data respectively in the case of a six bit serial multi-bit digital data signal.

Alternating the column conductor of a pair to which the input data is applied and inverting the input data can both affect the output voltage errors of the conversion means. There are four possible conditions for converting the data signals applied to a column conductor for any particular picture element within the display:

### A) Apply input data to the first column conductor and do not invert data bits.

### B) Apply input data to the first column conductor and invert data bits.

### C) Apply input data to the second column conductor and do not invert data bits.

### D) Apply input data to the second column conductor and invert data bits.

The effect that any mismatch in the capacitances of the column conductors has on the brightness of the picture element in the display, and therefore, the overall performance of the display, depends on the sequence of the drive conditions listed above which is used to generate the analogue drive column voltage with which the picture element is addressed.

If the sequence of the conversion conditions used to generate the data, grey-scale, voltage for a particular picture element in successive addressing periods is A, B, A, B, . . . or C, D, C, D, . . . then the errors in the output voltage of the conversion circuit translate into errors in the rms voltage appearing across the picture element. These will result in errors in the brightness of the picture element causing effects such as vertical lines or bands in the displayed images. Therefore the use of these sequences is undesirable.

Differences in the capacitance of the two column conductors which form a conversion circuit, however they are caused, will result in errors in the converted voltage. These errors are different depending on whether the digital data is applied to the first column conductor or the second column conductor. It is possible to reduce the effect that these errors have on the rms voltage experienced by the picture elements by alternating which column conductor the data is supplied to in synchronisation with the inversion of the picture element drive voltage. The column conductor to which the data is applied to generate the analogue voltage for a particular picture element should ideally be alternated each time that the polarity of the drive voltage for that picture element is inverted or every second time that the drive voltage for the picture element is inverted. The first case leads to the drive sequences ADADAD and CBCBCB. With these sequences, errors in output voltage of the conversion circuit resulting from capacitance matching errors lead mainly to errors in the mean voltage experienced by the picture element rather than the rms voltage. The errors in the mean voltage averaged over four field periods can be reduced in the second case in which use is made of all four combinations of drive polarity and column conductor. The preferred sequences are then ABCDABCD and DCBADCBA.

In principle other sequences of drive conditions could be used in which the inversion of the drive polarity or the alternation of the column conductors occurs at a lower frequency but these may lead to low frequency variations in the light output of the display i.e. flicker.

In conventionally driven AMLCDs a number of inversion schemes are known in which the polarity of the drive voltages applied to the picture elements are arranged in various patterns, for example row inversion, column inversion and dot inversion. The sequence of conversion conditions used to provide the drive voltages for the picture elements can be spatially varied in a similar manner to these inversion schemes in order to minimise the visibility of flicker resulting from the conversion voltage errors.

In the embodiment described above, the column conductors of a conversion means to which data signals are applied is changed after each complete multi-bit data signal conversion process. However, the alternation of the supply of data signals to the two column conductors of a conversion means may be varied, whilst similarly achieving an improvement in display quality by reducing conversion errors. For example, the column conductor to which input data is applied may be changed after a predetermined plurality of successive, complete, conversion processes. Alternatively, the alternation of the column conductors may instead occur during a conversion process, after a predetermined number, n, of bits of the serial, multi-bit data signal, where n≧1. In both these cases, the column conductor to which the data signal, or the first bit of the data signal, is applied is preferably changed for each successive frame as well.

Although the two column conductors forming a conversion means in the example embodiment described above comprise column conductors which lie directly adjacent one another, different arrangements are possible and two column conductors not immediately neighbouring one another may be used for a conversion means. In this case there will be some interleaving of the circuits of the plurality of conversion means.

The switches 31A, 31B, and 31C of each conversion means may be implemented using individual transistors or alternatively CMOS transmission gates.

Although the invention has been described in relation particularly to AMLCDs, it is envisaged that it can be applied to similar advantage in other kinds of active matrix display devices.

From reading the present disclosure, other modifications will be apparent to persons skilled in the art. Such modifications may involve other features which are already known in the field of active matrix display devices and component parts therefor and which may be used instead of or in addition to features already described herein.

1. An active matrix display device comprising a row and column array of picture elements (12), sets of row and column address conductors (18, 19) for selecting rows of picture elements and providing data signals to the picture elements of a selected row respectively, drive means (21, 23, 25) for supplying selection signals and multi-bit digital data signals respectively to the set of row address conductors and the set of column address conductors, and in which the multi-bit digital data signals supplied to the column address conductors are converted into analogue voltage levels for use by the picture elements by a plurality of serial charge redistribution digital to analogue conversion means (30), each conversion means (30A, 30B, 30C) comprising at least first and second capacitances interconnectable by at least one conversion switch (31) and between which charge is shared, and in which the first and second capacitances of a conversion means are provided by the capacitances of two column address conductors, wherein the drive means is arranged to alternate the supply of data signals to the first and second column address conductors of each conversion means.

2. A device according to claim 1, wherein the column address conductor (19) of a conversion means to which the data signals are applied is changed after one or more complete multi-bit signal conversions performed by the conversion means (30).

3. A device according to claim 1, wherein the supply of data signals to the column address conductors (19) of each conversion means is controlled by a switch arrangement (31A, 31C).

4. A device according to claim 3, wherein the switch arrangements of all conversion means are operable together by the drive means.

5. A device according to claim 3, wherein the switch arrangement comprises a respective switch device (31A, 31C) connected between a column address conductor (19) and a serial digital data signal output (32) of the drive means.

6. A device according to claim 1, wherein the polarity of the voltage provided to the picture elements is inverted periodically, and wherein the alternation of the column conductors (19) of a conversion means to which a data signal is applied to generate the analogue voltage level for a given picture element is synchronised with the inversion of the picture element voltage.

7. A device according to claim 6, wherein the drive means and the conversion means are operable such that for a given picture element the column address conductor (19) of its associated conversion means to which a data signal is applied is changed each time the polarity of the picture element voltage is inverted.

8. A device according to claim 6, wherein the drive means and the conversion means are operable such that for a given picture element the column address conductor of its associated conversion means to which a data signal is applied is changed every second time the polarity of the picture element is inverted.

9. A device according to claim 1, wherein the picture elements comprise liquid crystal display elements.

10. A device according to claim 9, wherein the drive means is arranged to alternate the supply of data to the first and second column address conductors with a period which is shorter than the response time of the liquid crystal material.
